(19) United States
(12) Patent Application Publication
(10) Pub. No.: US 2025/0094909 A1
(43) Pub. Date: Mar. 20, 2025

(54) INFORMATION PROCESSING DEVICE, INFORMATION PROCESSING METHOD, AND INFORMATION PROCESSING PROGRAM

(71) Applicant: Nippon Telegraph and Telephone Corporation, Tokyo (JP)

(72) Inventors: Kimio TSUCHIKAWA, Musashino-shi, Tokyo (JP); Taisuke WAKASUGI, Musashino-shi, Tokyo (JP); Fumihiro YOKOSE, Musashino-shi, Tokyo (JP); Ryo UCHIDA, Musashino-shi, Tokyo (JP); Yuki Urabe, Musashino-shi, Tokyo (JP); Sayaka Yagi, Musashino-shi, Tokyo (JP)

(21) Appl. No.: 18/727,133

(22) PCT Filed: Jan. 14, 2022
(86) PCT No.: PCT/JP2022/001246

§ 371 Date: Jul. 8, 2024

(51) Int. Cl. G06Q 10/0639; G06Q 10/0631

(52) U.S. Cl. CPC G06Q 10/0639; G06Q 10/06316

(57) ABSTRACT

An information processing apparatus acquires an operation log regarding operation information, analyzes the operation log, and specifies attribute information of the operation log. Then, the information processing apparatus visualizes an image including an object on the basis of the specified attribute information, where the object is an object of operation logs in predetermined units and is selectable by an operation of a user. Next, the information processing apparatus generates a feasible automatic operation program on the basis of a selected object in a case where the object included in the visualized image is selected by the operation of the user.

### TECHNICAL FIELD

The present invention relates to an information processing apparatus, an information processing method, and an information processing program.

### BACKGROUND ART

In company activities, it is important to efficiently and smoothly advance daily business operations in order to continue the company activities. Since external and internal factors change in the environment surrounding business operations, it is necessary to continuously improve the business operations. In order to improve effective business operations, it is necessary to perform the steps of recognizing actual situations, discovering and analyzing points to be improved, drafting improvement plans, and executing the improvement plans in order.

For business efficiency, automation of business operations by using robotic process automation (RPA) as a powerful tool is spreading. However, in order to increase the effectiveness when introducing RPA, since there are the problems such as the know-how and skills required for analysts to find work suitable for RPA, and the entire business operations having to be comprehensively analyzed, RPA may not be able to be effectively used in many cases.

As a mechanism for solving this problem, a method of mechanically discovering repeated work through statistical analysis by using, as inputs, operation logs recording content of users' terminal operations as logs is known. By using such a method, it is possible to easily discover repeated work as a possible target of RPA without depending on know-how and skills.

In order to actually realize automation of business operations based on these results, the output results of these technologies cannot be directly used as inputs of the RPA tool, and an automatic operation program is thus manually created on the RPA tool while the output results are viewed.

### CITATION LIST

### Non Patent Literature

Non Patent Literature 1: Fumihiro Yokose and five others, “DX suishin ni koken suru gyomu kashika gijutsu (in Japanese) (Technology for Business Operation Visualization Contributing to DX Promotion)”, February 2020, NTT Technical Journal, pp. 72-75

### SUMMARY OF INVENTION

### Technical Problem

However, the conventional technique has a problem that the output results cannot be directly used as the inputs of the RPA tool and the automatic operation program cannot be easily created. For example, the conventional process mining technology requires manual creation of an operation scenario with the RPA tool while analysis results are viewed with the RPA tool separately activated, and has a problem that it takes time and effort.

The present invention was made in view of the above, and an object thereof is to provide an information processing apparatus, an information processing method, and an information processing program capable of creating an automatic operation program.

### Solution to Problem

In order to solve the aforementioned problem and achieve the object, an information processing apparatus according to the present invention includes: an analysis unit that acquires an operation log regarding operation information, analyzes the operation log, and specifies attribute information of the operation log; a visualization unit that visualizes an image including an object on the basis of the attribute information specified by the analysis unit, the object being an object of operation logs in predetermined units and being selectable by an operation of a user; and a cooperation unit that generates a feasible automatic operation program on the basis of a selected object in a case where the object included in the image visualized by the visualization unit is selected by the operation of the user.

### Advantageous Effects of Invention

According to the present invention, it is possible to easily create an automatic operation program.

### BRIEF DESCRIPTION OF DRAWINGS

FIG. 1 is a block diagram illustrating an example of a configuration of an information processing apparatus.

FIG. 2 is a diagram illustrating an example of an operation log stored in an operation log storage unit.

FIG. 3 is a diagram illustrating a relationship between a business operation, a work, a case, and an operation type.

FIG. 4 is a diagram illustrating an example of a data configuration of an operation log.

FIG. 5 is a diagram illustrating an example of a classification result.

FIG. 6 is a diagram illustrating an example of a data configuration of an operation log with a label applied thereto.

FIG. 7 is a diagram illustrating an example of an operation log to which a column of operation content is added.

FIG. 8 is a diagram illustrating an example of operation logs in the chronological order.

FIG. 9 is a diagram illustrating an example of a co-occurrence matrix.

FIG. 10 is a diagram for explaining similarity calculation processing.

FIG. 11 is a diagram for explaining operation log dividing processing.

FIG. 12 is a diagram illustrating an example of a classification result.

FIG. 13 is a diagram illustrating an example of the number of operation types of each operation set.

FIG. 14 is a diagram illustrating an example of operation logs in the chronological order.

FIG. 15 is a diagram illustrating an example of a co-occurrence matrix.

FIG. 16 is a diagram for explaining an example of how to weight a co-occurrence matrix depending on a distance.

FIG. 17 is a diagram for explaining an example of how to weight a co-occurrence matrix depending on whether or not operations have been performed in the same window.

FIG. 18 is a diagram for explaining centroid vector calculation processing.

FIG. 19 is a diagram illustrating transition of similarity.

FIG. 20 is a diagram for explaining an example of divided operation sets.

FIG. 21 is a diagram for explaining operation sequence classification processing.

FIG. 22 is a diagram for explaining operation sequence classification processing.

FIG. 23 is a diagram illustrating an example of an operation log.

FIG. 24 is a diagram illustrating an example of work model information.

FIG. 25 is a diagram illustrating an example of a work model creation screen.

FIG. 26 is a diagram for explaining an information providing procedure.

FIG. 27 is a diagram for explaining an information providing procedure.

FIG. 28 is a diagram illustrating an example of a screen in which an operation log is visualized in a time line format.

FIG. 29 is a diagram illustrating an example of a screen in which an operation process is visualized.

FIG. 30 is a diagram illustrating an example of a screen in which operations are visualized in predetermined units.

FIG. 31 is a diagram illustrating an example of a screen on which a user creates a desired automatic operation flow.

FIG. 32 is a flowchart illustrating an example of a processing procedure of operation log acquisition processing according to an embodiment.

FIG. 33 is a diagram illustrating an example of a computer that realizes an information processing apparatus by executing a program.

### DESCRIPTION OF EMBODIMENTS

Hereinafter, an embodiment of an information processing apparatus, an information processing method, and an information processing program according to the present application will be described in detail with reference to the drawings. Moreover, the present invention is not limited to the embodiment described below.

### [Configuration of Information Processing Apparatus]

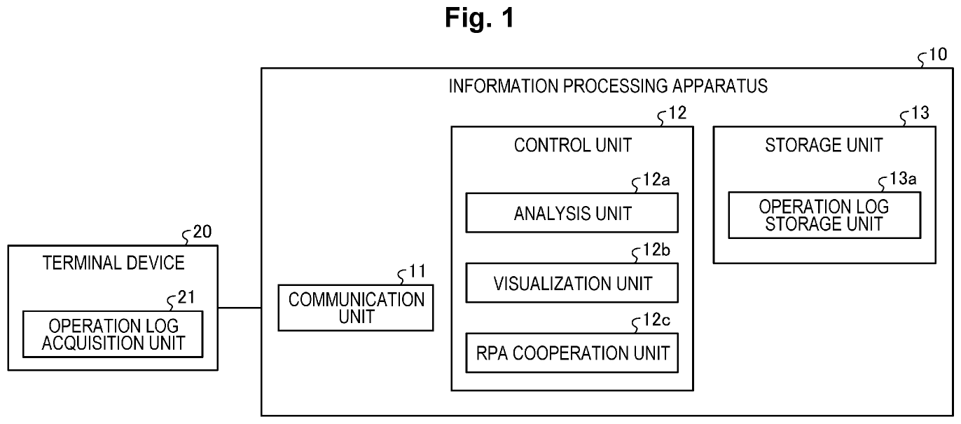

FIG. 1 is a block diagram illustrating an example of a configuration of an information processing apparatus. As illustrated in FIG. 1, an information processing apparatus 10 according to the present embodiment is connected to a terminal device 20 via a network (not illustrated). The information processing apparatus 10 is an information processing apparatus that is realized by, for example, a general-purpose computer such as a personal computer and executes processing of visualizing an operation process for each piece of work by forming an operation log based on a series of operation events (work model) of the work presented by a user and automatically providing work information and case information. Note that the information processing apparatus 10 may be any type of information processing apparatus including a server.

The terminal device 20 is an information processing apparatus used by a user. The user is, for example, a person in charge of business operations. For example, the person in charge of business operations uses various types of software such as a business operation system and a general-purpose application, for example, on the terminal device 20. Note that the terminal device 20 may be any type of information processing apparatus, which includes a client device such as a smartphone, a desktop PC, a notebook PC, or a tablet PC. While the information processing apparatus 10 and the terminal device 20 are separate devices in the example of FIG. 1, the terminal device 20 may have some or all of functions of the information processing apparatus 10.

The terminal device 20 includes an operation log acquisition unit 21. The operation log acquisition unit 21 acquires an operation log of a user. For example, the operation log acquisition unit 21 acquires an operation log including an operation time, an operation location, an operation position, and the like at the timing of an operation event. Here, the operation log acquisition unit 21 generates an operation log as a basis of analysis including information regarding an operation type and an operation location, which is a minimum unit of an RPA scenario, by detecting an event occurring with an operation from an OS or a GUI framework and acquiring information regarding a GUI part to record content of an operation on the terminal device 20 as a log, for example. The terminal device 20 transmits the operation log to the information processing apparatus 10.

The information processing apparatus 10 receives the operation log acquired by the operation log acquisition unit 21 of the terminal device 20 and stores the operation log in an operation log storage unit 13a of a storage unit 13. Note that a timing at which the information processing apparatus 10 and the terminal device 20 transmit and receive an operation log may be any timing and the information processing apparatus 10 and the terminal device 20 may perform transmission and reception at predetermined time intervals or may perform transmission and reception every time the operation log acquisition unit 21 acquires an operation log.

The information processing apparatus 10 includes a communication unit 11, a control unit 12, and the storage unit 13. Hereinafter, processing of each unit included in the information processing apparatus 10 will be described.

The communication unit 11 is implemented by a network interface card (NIC) or the like, and controls communication between an external device and the control unit 12 via a telecommunication line such as a local area network (LAN) or the Internet. For example, the communication unit 11 receives an operation log from the terminal device 20.

The storage unit 13 stores data and programs necessary for various types of processing performed by the control unit 12, and includes the operation log storage unit 13a. For example, the storage unit 13 is a semiconductor memory element such as a random access memory (RAM) or a flash memory, or a storage device such as a hard disk or an optical disc.

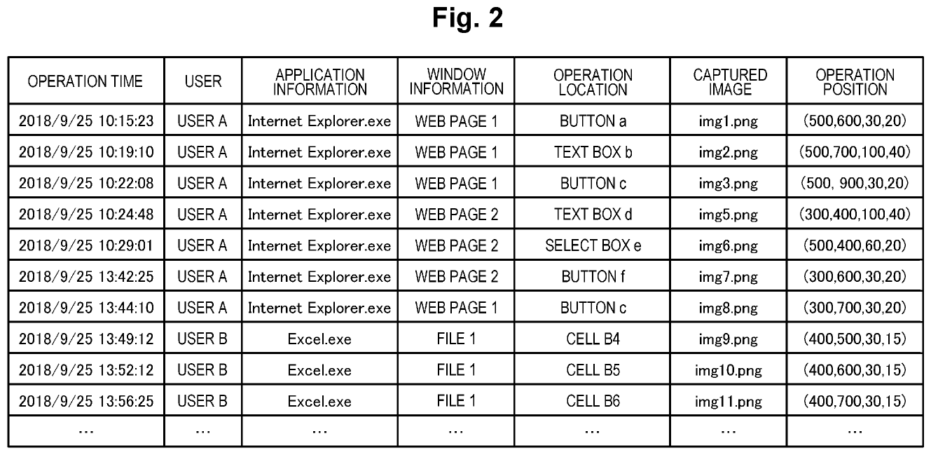

The operation log storage unit 13a stores an operation log acquired from the terminal device 20. For example, as illustrated as an example in FIG. 2, the operation log storage unit 13a stores, as an operation log, a table including columns of “operation time” indicating a time when an operation has been performed, “user” indicating a user who has performed the operation, “application information” indicating an application to be operated, “window information” indicating a window title or the like of a window to be operated, “operation location” indicating an operation location, “captured image” which is an image at the time of the operation, and “operation position” indicating a position where the operation has been performed. FIG. 2 is a diagram illustrating an example of an operation log stored in the operation log storage unit.

The control unit 12 includes an internal memory for storing a program defining various processing procedures and the like and required data, and performs various types of processing using the program and the data. For example, the control unit 12 includes an analysis unit 12a, a visualization unit 12b, and an RPA cooperation unit 12c. Here, the control unit 12 is an electronic circuit such as a central processing unit (CPU) or a micro processing unit (MPU), or an integrated circuit such as an application specific integrated circuit (ASIC) or a field programmable gate array (FPGA).

The analysis unit 12a acquires an operation log related to operation information, analyzes the operation log, and specifies attribute information of the operation log. For example, the analysis unit 12a specifies business operation information indicating content of business operation of the operation log, specifies work information indicating content of work of the operation log included in each piece of the specified business operation information, and specifies case information of the operation log included in each piece of the specified content of work. Also, the operation log may specify an operation type of the operation log included in each piece of the specified content of work.

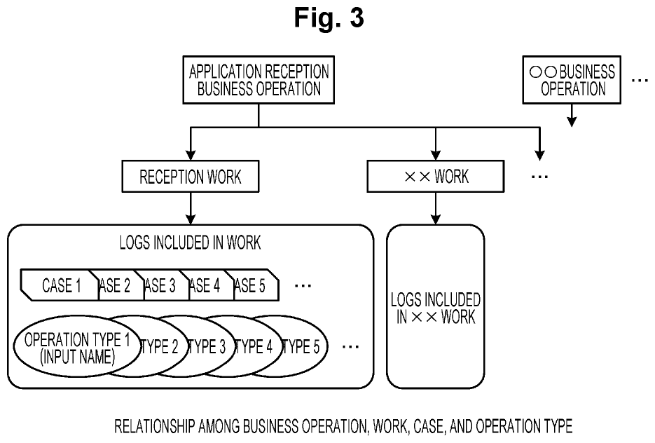

Here, a relationship among a business operation, a work, a case, and an operation type will be described by using FIG. 3. FIG. 3 is a diagram illustrating a relationship among a business operation, a work, a case, and an operation type. The analysis unit 12a analyzes the operation log acquired from the terminal device 20 and specifies and provides attribute information. As illustrated as an example in FIG. 3, the analysis unit 12a has a hierarchical structure of “business operation”, “work”, and “case/operation type”. The analysis unit 12a specifies and provides a business operation ID, a work ID, a case ID, and an operation type ID as each piece of attribute information.

For example, the analysis unit 12a extracts business operation classification, work classification, and a main flow useful for business operation analysis by mechanically analyzing the operation log. The analysis unit 12a focuses on unity of work as the work classification and applies a work tag to the operation log by gathering works depending on co-occurrence. In addition, the analysis unit 12a focuses on, for example, a relevance between a business operation document and an operation screen as business operation classification and applies a business operation tag to the operation log. In addition, the analysis unit 12a may extract a main operation column (main flow) by arranging operation logs and extracting operations that commonly appear in many operation columns as main flow extraction.

Hereinafter, specific processing will be described in the order of business operation ID specifying processing, work ID specifying processing, and case ID specifying processing. Note that the processing of specifying and providing the business operation ID, the work ID, and the case ID is not necessarily all automatic and may be manual processing.

### [Business Operation ID Specifying Processing]

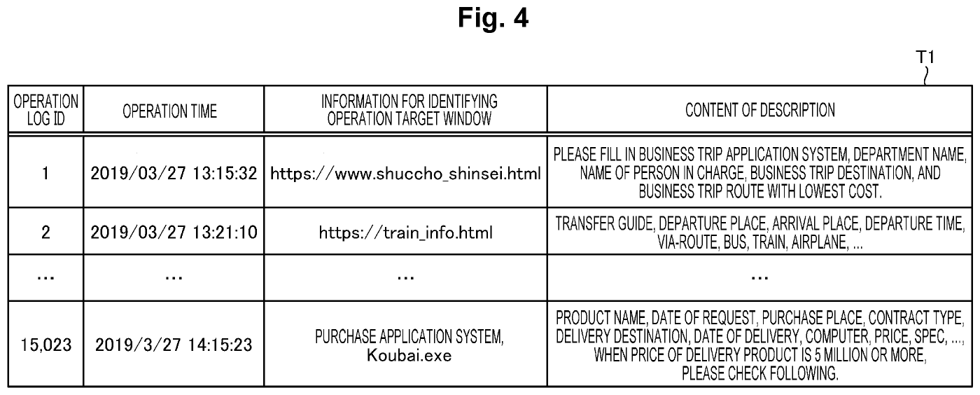

First, the business operation ID specifying processing will be described. An example of an operation log used for the description here will be described. FIG. 4 is a diagram illustrating an example of a data configuration of an operation log. As illustrated in a table T1 of FIG. 4, the operation log includes an operation log ID, an operation time, information for identifying an operation target window, and items of description contents. The operation log ID is a value unique to each operation log, which is given when the operation log is accumulated. The operation time is a time at which the operation log is acquired. The information for identifying the operation target is a window title, a URL, a file path, an application name, and the like of the operation target window. The description content is text information in the operation target window.

For example, the operation log with the operation log ID “1” is an operation log acquired at “2019 Mar. 27 13:15:32”. In the operation log having the operation log ID “1”, the operation target is “https://www.shuccho_shinsei.html”, and the description content is “Please fill in the travel application system, a department name, a name of a person in charge, a travel destination, and a business trip route with the lowest cost.”.

First, the analysis unit 12a divides text information of “description content” corresponding to each of IDs of operation logs into words for operation logs to be processed, and creates a vector (hereinafter, referred to as an operation log vector) by using a word set in the description content of the operation logs. The analysis unit 12a creates a word vector for each of IDs of the operation logs by using a method such as Bag-of-Words, TF-IDF, or Word2Vec.

Additionally, the analysis unit 12a can also adopt a method of creating a vector by using only common words among the word set in the description content of the operation logs. In this case, the following procedure is added instead of the above procedure. First, the analysis unit 12a classifies the operation logs for each operation target window. The analysis unit 12a compares the same operation screens from identification information of the operation screens of the operation logs. In this manner, the analysis unit 12a compares all the operation logs in the operation target window and extracts a common word set, that is, a word set appearing in each operation log. Then, the analysis unit 12a creates an operation log vector from the extracted word set. By adopting this method, the analysis unit 12a can perform accurate classification without being affected by words appearing the individual cases.

Subsequently, the analysis unit 12a classifies a plurality of operation logs into a plurality of groups by using a document classification method on the basis of the operation log vectors. The analysis unit 12a uses a clustering method such as a topic model, X-means, or K-means as a document classification method. The number of groups of classification can be set by automatic estimation or can be manually set.

Then, the analysis unit 12a determines a label of each group. The analysis unit 12a extracts a characteristic word in each group, determines the extracted word as a label, and gives the label to an operation log corresponding to each group. The characteristic word is a word having a high appearance rate in distribution of word appearance frequencies (hereinafter, it is referred to as “word distribution”). Alternatively, the characteristic word is a word that frequently appears only in a specific group and does not exist in the other groups or has a low frequency.

For example, a case where a topic model is used will be described. The analysis unit 12a acquires the distribution of word appearance frequencies for each topic when the plurality of operation logs are classified into a plurality of groups by using the topic model. Then, the analysis unit 12a extracts a word having a large distribution ratio for each topic as a group label. Then, the classification unit 142 provides the extracted label to the corresponding group.

In addition, a case where a clustering method such as X-means is used will be described. The analysis unit 12a classifies a plurality of operation logs into each group by using a clustering method. Thereafter, the analysis unit 12a extracts a word having a high appearance frequency only in the specific group and having no appearance or low frequency in the other groups as a group label. Then, the analysis unit 12a provides the extracted label to the corresponding group.

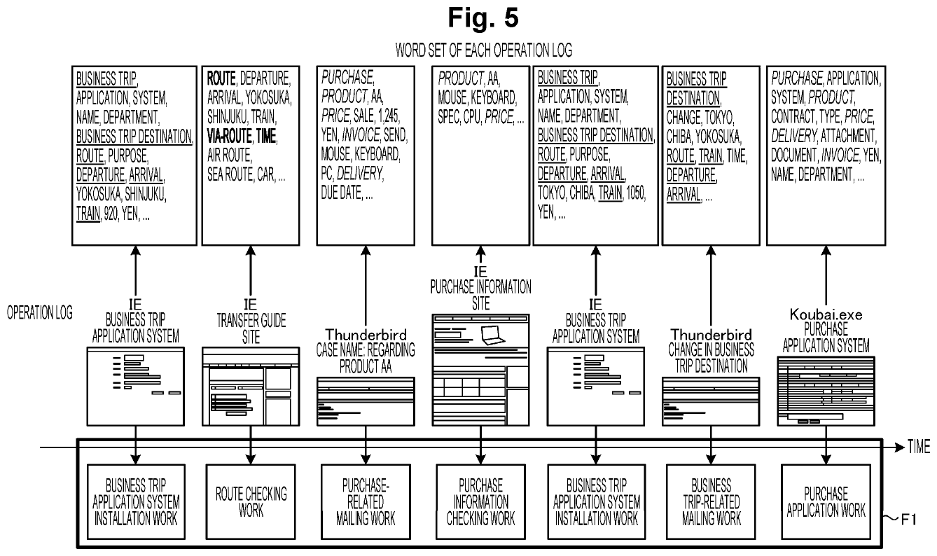

FIG. 5 is a diagram illustrating an example of a classification result. In FIG. 5, it is assumed that a person in charge performs a business trip application work and a purchase application work and acquires the operation log illustrated in the upper part of FIG. 5 as a specific example. In addition, a word set in each operation log is illustrated as an example. A frame F1 in the lower part of FIG. 5 indicates a label provided to each of groups of operation logs by the analysis unit 12a.

Here, it is considered that many common words appear in the operation logs corresponding to the same work. On the other hand, it is considered that words that frequently appear in each operation log are different in a case of operation logs of different works.

In the case of the example of FIG. 5, many words related to the business trip system such as “business trip, route, departure, . . . ” with underlines appear in the “business trip system input work” of the “business trip application business operation”. In addition, many words related to the route such as “route, via-route, time, . . . ” illustrated by the bold letters appear in the “route checking work”.

From the above, the analysis unit 12a performs classification on the basis of the word set of the operation logs and can thereby classify the operation logs into a plurality of groups depending on granularity of work.

In addition, it is desirable that the label provided to each group be a name that is used only for the work so that a person can recognize which work it is. Therefore, the method of adopting a word having a high appearance frequency in a specific group but not appearing or having a low frequency in the other groups as a label is conceivable. In the case of the example of FIG. 5, “name”, “department”, and “system” are not suitable as labels since their appearance rates themselves are high in the business trip application system and the purchase application system and they appear in both the groups.

On the other hand, words such as “business trip, route, departure, . . . ” with underlines, words “route, via-route, time, . . . ” illustrated in the bold letters, and words such as “purchase, product, price, . . . ” illustrated in the bold italic letters have high appearance frequencies in each group and low appearance frequencies in other groups. Therefore, the analysis unit 12a uses these words as words representing the work, that is, as labels, so that a business operation analyst can easily recognize what kind of work the operation log of each group corresponds to without the business analyst himself/herself performing the processing.

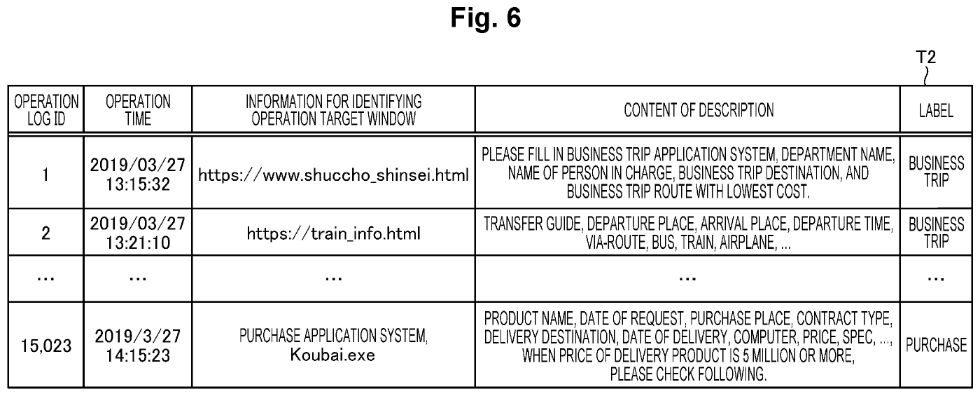

FIG. 6 is a diagram illustrating an example of a data configuration of an operation log with a label applied thereto. As illustrated in a table T2 of FIG. 6, a label of a group to which an operation log belongs is attached as a business operation ID to a label section of each operation log after the classification performed by the analysis unit 12a. For example, “business trip” is attached as a label to the operation log having the operation log ID “1”.

### [Work ID Specifying Processing]

Next, work ID specifying processing will be described. In the following work ID specifying processing, the operation logs are classified for each business operation ID (label) provided in the above-described business operation ID specifying processing and the work ID specifying processing is performed for each business operation.

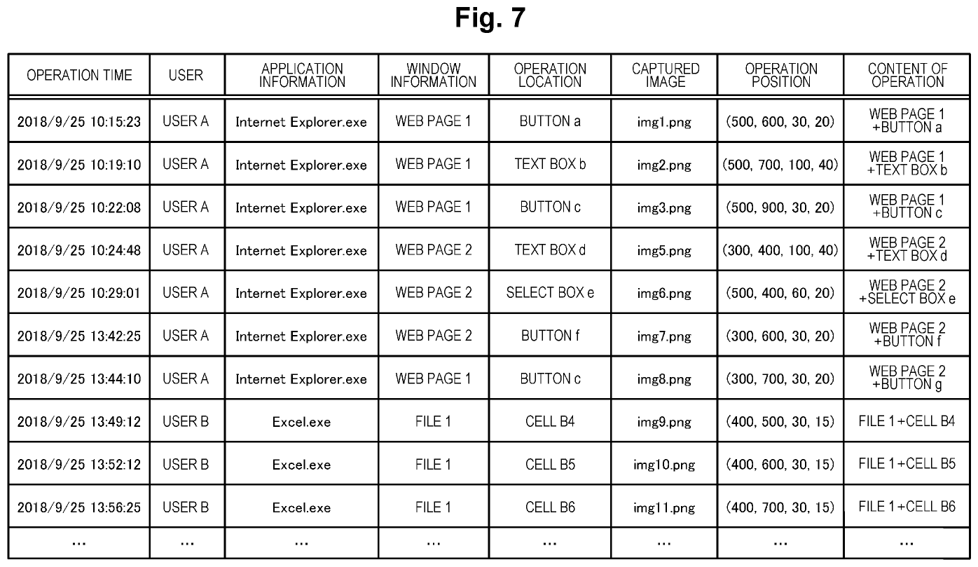

The analysis unit 12a acquires an operation log and specifies each operation performed by the user using the operation log. For example, as illustrated as an example in FIG. 7, the analysis unit 12a reads the table of the operation logs from the operation log storage unit 13a, adds an “operation content” column, adds window information and operation location information to the “operation content” column, and stores the information in the operation log storage unit 13a. FIG. 7 is a diagram illustrating an example of an operation log for which a column of operation content has been added. Then, the analysis unit 12a specifies operations having the same “operation content” as operations of the same type.

In description of a specific example, in a case where there are a plurality of operations whose operation content is “web page 1+button a”, the analysis unit 12a specifies these operations as operations of the same type. Note that the analysis unit 12a may add a column of an operation ID for uniquely identifying the type of operation, for example, together with the “operation content” column or instead of the “operation content” column in order to specify operations of the same type.

The analysis unit 12a creates a vector of each operation on the basis of a co-occurrence relationship between the specified operations. For example, the analysis unit 12a counts the number of times other operations are performed within a predetermined number range before and after an operation sequence performed in a chronological order for each of specified operations, creates a co-occurrence matrix representing a co-occurrence relationship between the operations by using the counted number of times, and creates a vector of each operation on the basis of the co-occurrence matrix.

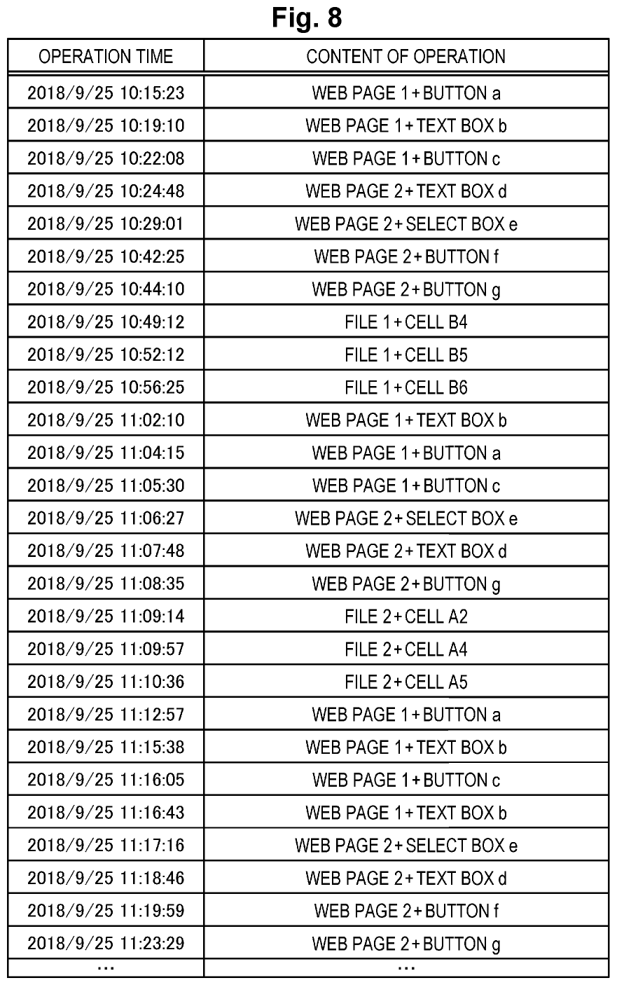

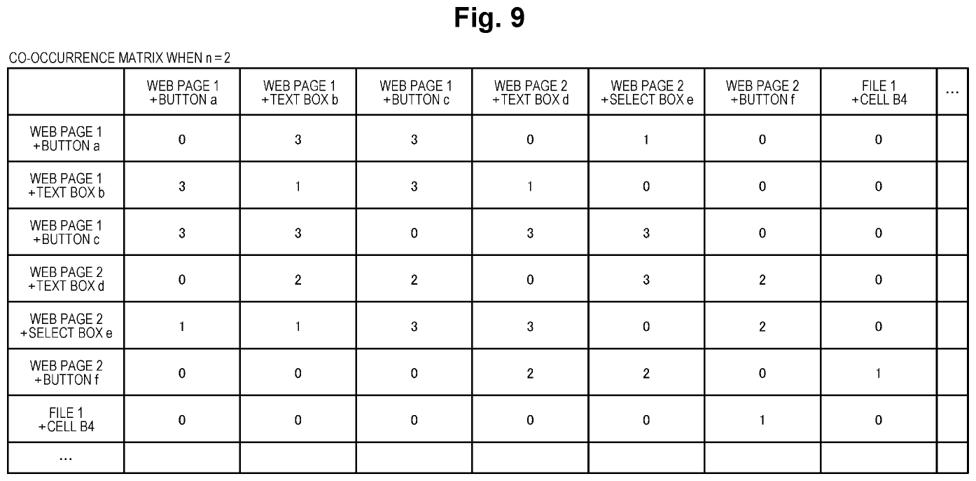

Here, processing of creating a co-occurrence matrix will be described by using examples in FIGS. 8 and 9. FIG. 8 is a diagram illustrating an example of operation logs in the chronological order. FIG. 9 is a diagram illustrating an example of a co-occurrence matrix created by an operation vector creation unit. For example, the analysis unit 12a reads “operation content” added to the operation logs in the chronological order as illustrated as an example in FIG. 8. Then, the analysis unit 12a creates a co-occurrence matrix by counting n operations before and after each operation as illustrated as an example in FIG. 9. In the example of FIG. 9, the analysis unit 12a creates the co-occurrence matrix in a case where it is assumed that n=2.

Then, the analysis unit 12a creates a vector for each operation from the co-occurrence matrix. Regarding the created vector, the magnitude of the vector is the number of types of operations, and each element includes the number of counts of n operations before and after the target operation. Description will be given by using the example in FIG. 9. The analysis unit 12a creates a web page 1+button a=[0, 3, 3, 0, 1, 0, 0 . . . ] as a vector of operation content [web page 1+button a] and creates a web page 1+text box b=[3, 1, 3, 1, 0, 0, 0 . . . ] as a vector of operation content [web page 1+text box b], for example.

Furthermore, in a case where the specified type of operation is equal to or greater than a predetermined threshold value, the analysis unit 12a may create the vector of each operation by using a predetermined dimension reduction method. In other words, when a vector of each operation is created from a co-occurrence matrix of each operation, the length of the vector corresponds to the number of operation types, and the larger the number of operation types is, the higher the calculation cost becomes. Therefore, the analysis unit 12a may reduce the dimension of each operation vector by using a dimension reduction method such as single value decomposition (SVD). As a result, the calculation cost can be reduced.

The analysis unit 12a calculates similarity between a predetermined number of operations adjacent to each other in the chronological order by using the created vector of each operation. For example, the analysis unit 12a calculates each centroid vector or a sum vector for each of the predetermined number of operation sequences adjacent to each other in the chronological order and calculates similarity between the vectors by using the created vector of each operation.

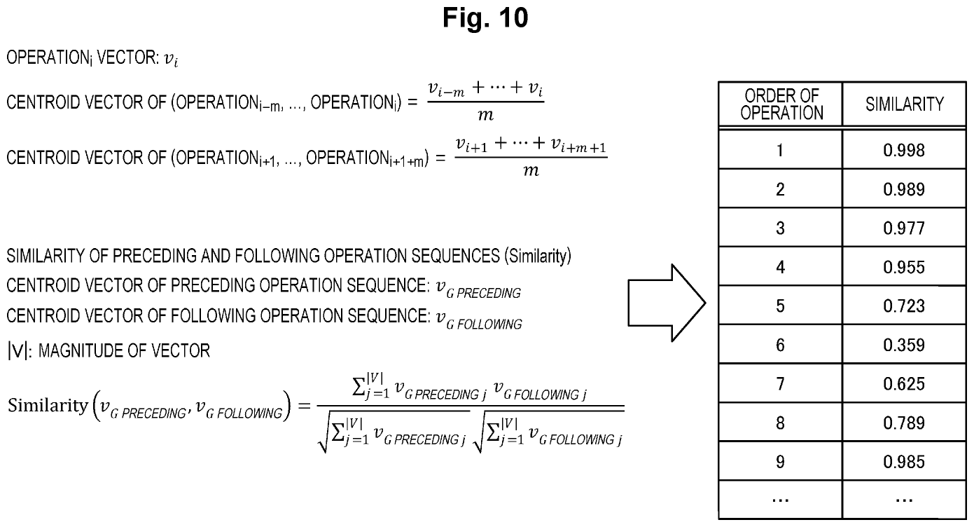

Here, similarity calculation processing will be described by using FIG. 10. FIG. 10 is a diagram for explaining similarity calculation processing. For example, as illustrated as an example in FIG. 10, the analysis unit 12a reads operation logs in the chronological order, and calculates a centroid vector or a sum vector by using each of the operation vectors of m preceding operation sequences (operationᵢ₋ₘ, . . . , operationᵢ) including an operationᵢ to be divided and m operation sequences (operationᵢ₊₁, . . . , operationᵢ₊₁₊ₘ) after the operationᵢ.

Then, the analysis unit 12a calculates the similarity between the preceding and following operation sequences by using a vector similarity calculation method such as cosine similarity or Euclidean distance, for example. Thereafter, the analysis unit 12a stores the operation order and the similarity in the storage unit 13. For example, “1” in the operation order refers to a part between the first operation and the second operation in the chronological order.

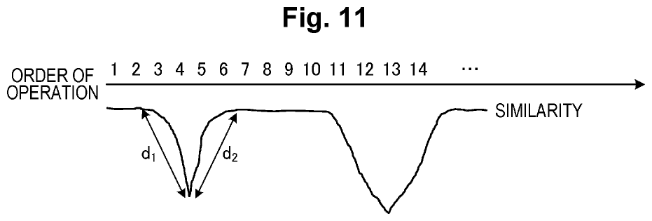

The analysis unit 12a determines a division point of each operation by using the similarity and divides chronological operations into operation sets on the basis of the division point. FIG. 11 is a diagram for explaining operation log division processing performed by a determination unit. For example, as illustrated as an example in FIG. 11, if the “operation order” and the “similarity” are read from the analysis unit 12a, and the similarity has been calculated from the cosine similarity, then the analysis unit 12a finds a length (d₁) from the start of the decrease in similarity to the minimum point of the similarity and a length (d₂) from the minimum point to the end of the increase in similarity to calculate a depth (d=d₁+d₂) using the lengths. On the other hand, in a case where the similarity is calculated from the Euclidean distance, the analysis unit 12a finds a length from the start of the increase in similarity to the maximum point of the similarity and a length from the maximum point to the end of the decrease in similarity to calculate the depth thereof.

Then, if the depth is equal to or greater than a threshold value, the analysis unit 12a sets the part of the minimum point (or the maximum point) as the work division point and divides the operation log. The analysis unit 12a repeats the processing until the determination is made for all the operations in order. For example, as illustrated as an example in FIG. 11, in a case where “4” of the operation order is determined to be the division point, the analysis unit 12a divides operation logs at a part between the fourth and fifth operation logs. Note that the processing of determining the division point is not limited to the case of determining whether the depth (d=d₁+d₂) is equal to or greater than a threshold value, and the determination unit 12d may determine whether both the length (d₁) from the start of decrease in similarity to the minimum point of similarity and the length (d₂) from the minimum point to the end of increase in similarity are equal to or greater than a predetermined threshold value, and may determine that the part of the minimum point (or maximum point) is the division point of the work when both lengths are equal to or greater than the predetermined threshold value.

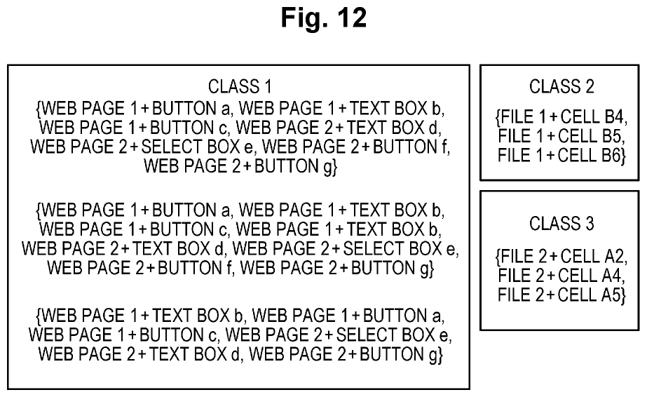

Then, the analysis unit 12a classifies each divided operation set into classes on the basis of the number of types of operations common to the operation sets. For example, the analysis unit 12a compares the types of operations of an operation set appearing in a classified class with the types of operations of an operation set to be classified, and calculates the number of common operation types. Then, the analysis unit 12a classifies the classification target operation set into a class in which the number of common operation types is equal to or greater than a threshold value and is the largest, and if the number of common operation types is equal to or smaller than the threshold value, the analysis unit 12a classifies the operation set into a new class. As a result, the analysis unit 12a classifies the divided operation sets into classes 1 to 3 as illustrated as an example in FIG. 12, for example. FIG. 12 is a diagram illustrating an example of the classification result.

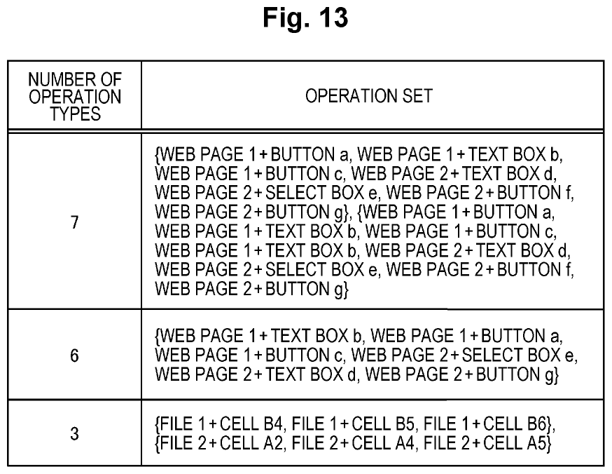

Furthermore, the analysis unit 12a may classify operation sets in descending order from the largest number of operation types, for example. In this case, the analysis unit 12a obtains the number of operation types for each operation set and classifies the operation sets in descending order from the largest number of operation types, as illustrated as an example in FIG. 13. FIG. 13 is a diagram illustrating an example of the number of operation types of each operation set. Note that the analysis unit 12a is not limited to the case of classifying operation sets in descending order from the largest number of operation types and may classify the operation sets in the chronological order, for example. Furthermore, as an another method, the analysis unit 12a may create a vector obtained by setting the number of types of operations as the number of dimensions and counting operations appearing an operation set for each operation set and may classify the operation set on the basis of a threshold value by using a method such as a hierarchical clustering method or the like.

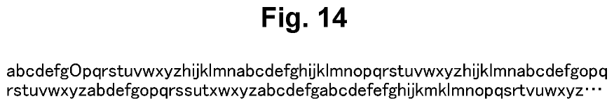

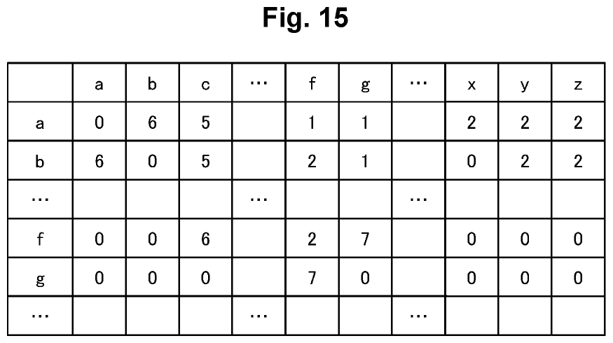

Hereinafter, in regard to chronological operations illustrated in FIG. 14, a series of processing for the analysis unit 12a to classify the operation logs for each work will be described using specific examples of FIGS. 15 to 21. FIG. 14 is a diagram illustrating an example of operation logs in the chronological order. Each character illustrated as an example in FIG. 14 indicates an operation specified by the same operation specification unit 12a, and the same character indicates the same type of operation. In other words, the operation sequence illustrated as an example in FIG. 14 means that operations have been performed in the order of a, b, c, d, e, f . . . . Note that in the operation sequence of FIG. 14, it is assumed that “abcdefg” are operations of work 1, “hijklmn” are operations of work 2, “opqrstuvwxyz” are operations of work 3, and there are three types of classified works.

FIG. 15 is a diagram illustrating an example of a co-occurrence matrix. As illustrated in FIG. 15, the analysis unit 12a creates a co-occurrence matrix by using n operations before and after each operation. In the example of FIG. 15, n=3. A value of n is set as a range of preceding and following operations determined to be co-occurring operations. In addition, regarding creation of the co-occurrence matrix, weighting may be performed depending on not only the count of the presence or absence of the operation but also the adjacency situation of the operations before and after the target operation and whether or not the operation is in the same window. In this manner, the analysis unit 12a can create a co-occurrence matrix in consideration of the actual operation situation and can thus more accurately perform processing of classifying work groups.

For example, the analysis unit 12a may create a co-occurrence matrix by using the number of times other operations have been performed within a predetermined range before and after an operation sequence performed in the chronological order and values obtained by applying weights in addition to the distances to those other operations for each operation, and may create a vector of each operation on the basis of the co-occurrence matrix.

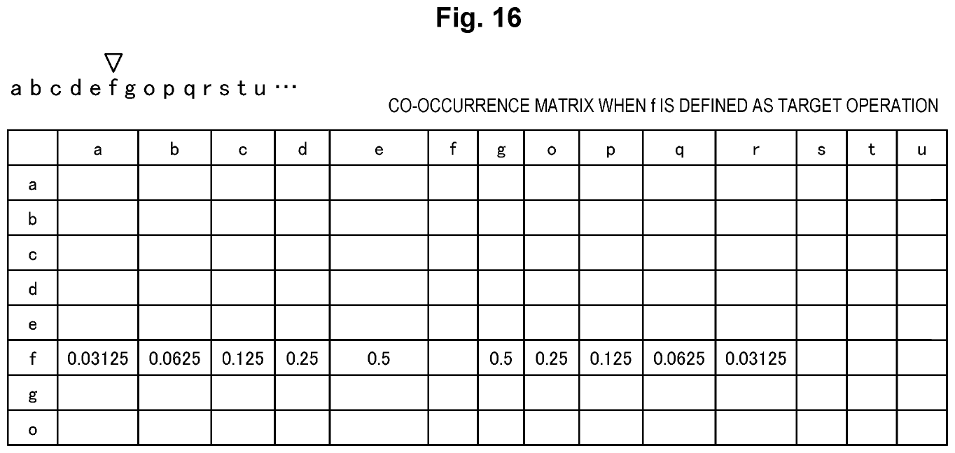

FIG. 16 is a diagram for explaining an example of how to weight a co-occurrence matrix depending on the distance. In the example of FIG. 16, it is assumed that n=5. As illustrated as an example in FIG. 16, for example, in a case where the analysis unit 12a determines weights depending on the distance between the target operation and another operation, the distance of the target operation “f” to the operation “e” and the operation “g”, which are adjacent operations is “1”, and in the case where the distance is “1”, counting is performed by using 0.5 as a weight, thereby creating a co-occurrence matrix. Furthermore, the distance of the target operation “f” to the operation “d” and the operation “o” is “2”, and in the case where the distance is “2”, the analysis unit 12a performs counting by using 0.25 as a weight, thereby creating a co-occurrence matrix, for example.

In addition, the analysis unit 12a may perform weighting and counting depending on whether or not operations before and after the target operation have been performed in the same window (a web page, a file, or the like). For example, the analysis unit 12a may create the co-occurrence matrix by using a value obtained by weighting the number of times of other operations performed within a predetermined number range before and after the operation sequence performed in the chronological order depending on whether or not those other operations have been performed in the same window for each specified operation, and may create a vector of each operation on the basis of the co-occurrence matrix. Note that in this case, the analysis unit 12a may determine whether or not the operations before and after the target operation are on the same screen by using application information of the operation log and the window title of the window information for identification of the operations.

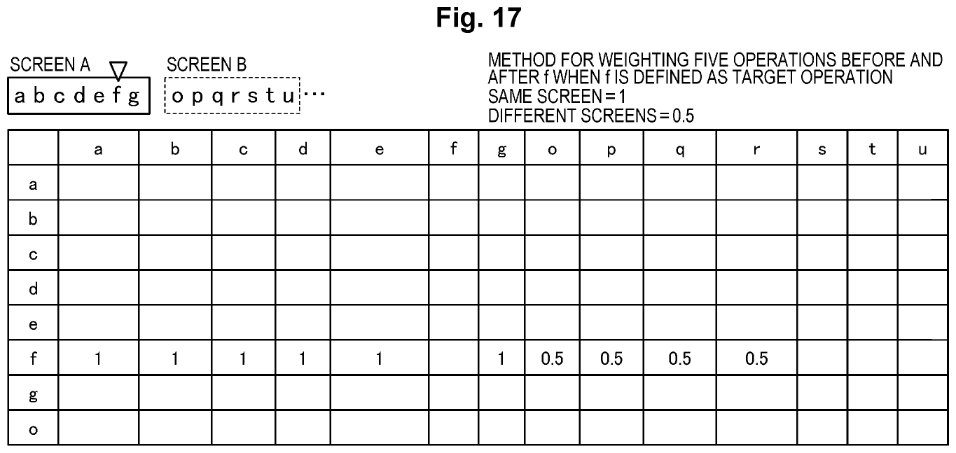

FIG. 17 is a diagram for explaining an example of how to weight a co-occurrence matrix depending on whether or not operations have been performed on the same window. In the example of FIG. 17, it is assumed that n=5, operations abcdefg are operations on the same screen (window) A, and operations opqrstu are operations on the same screen B. As illustrated as an example in FIG. 17, for example, in a case where the weight of the same window (screen) is “1” and the weight of another screen is “0.5”, the analysis unit 12a counts “1” as a weight for the operations abcdeg which are operations within five operations before and after the target operation “f” and have been performed on the same window as the target operation “f”, and creates a co-occurrence matrix. Furthermore, the analysis unit 12a counts “0.5” as a weight for the operations opqr which are operations within five operations before and after the target operation “f” and have been performed on a window different from that of the target operation “f”, and creates a co-occurrence matrix.

Then, the analysis unit 12a creates a vector of each operation from the co-occurrence matrix. Description will be given by using the example in FIG. 15, for example. The analysis unit 12a creates an operation a=[0, 6, 5 . . . 1, 1, . . . 2, 2, 2] by using the co-occurrence frequencies with all operations as a vector of the operation “a”, for example. Furthermore, when the number of types of operations is large, the analysis unit 12a may perform dimension reduction using SVD, and, for example, may perform dimension reduction to a 50 dimensional vector while holding features of 1000 types of operations.

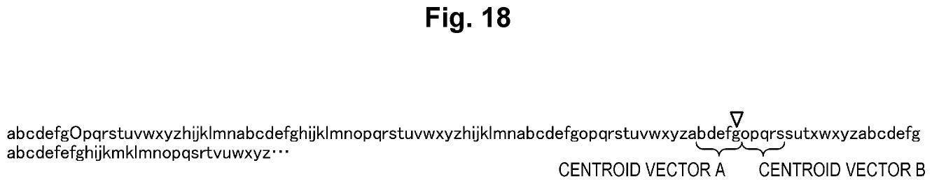

Subsequently, the analysis unit 12a reads operation logs in the chronological order, acquires m operations including an operation as a target of division determination and m operation sequences after the operation as the target of division determination, and calculates similarity between the m adjacent operation sequences (the operation sequence A in FIG. 18) including an operation on the target of division determination and the m operation sequences (the operation sequence B in FIG. 18) after the operation as the target of division determination by using the created vector of each operation. Here, centroid vector calculation processing will be described by using FIG. 18. FIG. 18 is a diagram for explaining centroid vector calculation processing. In the example of FIG. 18, it is assumed that m=5, and the operation “g” indicated by “V” is set as a target of division determination. In this case, the operation sequence A and the operation sequence B for which the similarity is to be calculated are the operation sequence A=bdefg and the operation sequence B=opqrs.

Then, the analysis unit 12a acquires a vector (operation vector) of each operation in the operation sequence A and calculates the centroid of the operation sequence A by using the following Expression (1).

$$\begin{matrix}[ Math . 1 ] & \\ Centroid of operation sequence A = \frac{Operation vectors of b , d , e , f , g}{m} & ( 1 )\end{matrix}$$

In addition, the analysis unit 12a similarly acquires a vector (operation vector) of each operation in the operation sequence B and calculates the centroid of the operation sequence B by using the following Expression (2).

$$\begin{matrix}[ Math . 2 ] & \\ Centroid of operation sequence B = \frac{Operation vectors o , p , q , r , s}{m} & ( 2 )\end{matrix}$$

Then, the analysis unit 12a calculates the similarity between the centroid vectors of the operation sequence A and the operation sequence B. In a case where the cosine similarity is adopted as the calculation of the similarity, for example, the analysis unit 12a calculates the similarity between the centroid vectors of the operation sequence A and the operation sequence B by using the following Expression (3).

$$\begin{matrix}[ Math . 3 ] & \\ \vec{a} = Centroid vector of operation sequence A & ( 3 )\end{matrix}$$

$$\vec{b} = Centroid vector of operation sequence B$$

$$cos ( \vec{a} \cdot \vec{b} ) = \frac{{\sum }_{i = 1}^{\vert V \vert} {a}_{i} {b}_{i}}{\sqrt{{\sum }_{i = 1}^{\vert V \vert} {a}_{i}^{2}} \sqrt{{\sum }_{i = 1}^{\vert V \vert} {b}_{i}^{2}}}$$

$$\vert V \vert is the number of dimensions of centroid vector$$

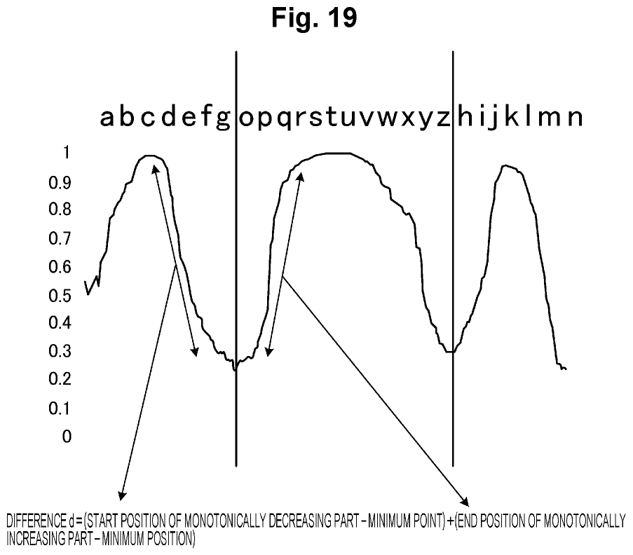

Then, the analysis unit 12a determines a part having a difference (difference d) equal to or greater than a threshold value among the similarities of the operation sequences before and after each operation in the operation log as a division point of the operation log, and divides the chronological operations into operation sets on the basis of the division point. FIG. 19 is a diagram illustrating transition of similarity. For example, as illustrated as an example in FIG. 19, the determination unit 12d calculates the difference d as follows.

$$Difference d = ( start position of monotonically decreasing part - minimum point ) + ( end position of monotonically increasing part - minimum point )$$

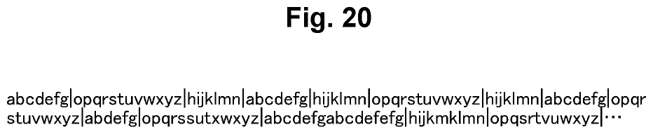

Then, in a case where the difference d is equal to or greater than the threshold value, the analysis unit 12a determines the part of the minimum point as a work division point. In the example of FIG. 19, the analysis unit 12a determines a point between the operation “g” corresponding to the part of the minimum point and the next operation “o” as a division point. In addition, the analysis unit 12a determines a point between the operation “z” corresponding to the part of the minimum point and the next operation “h” as a division point. Then, the analysis unit 12a divides the chronological operations illustrated as an example in FIG. 14 into a plurality of operation sets as illustrated as an example in FIG. 20 by dividing the operations on the basis of the division point. In the example of FIG. 20, the analysis unit 12a divides the chronological operations illustrated as an example in FIG. 14 into an operation set “abcdefg”, an operation set “opqrstuvwxyz”, an operation set “hijklmn”, and so on. FIG. 20 is a diagram for explaining an example of divided operation sets.

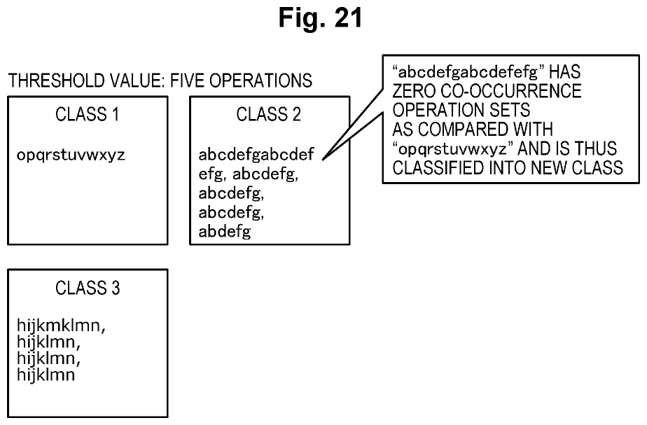

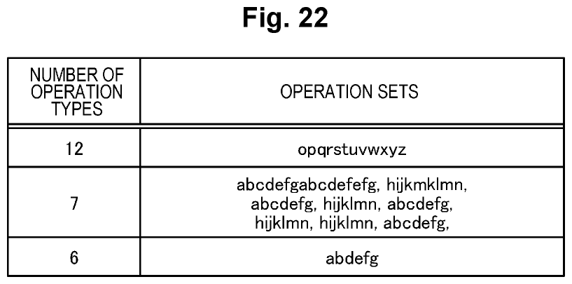

Subsequently, operation sequence classification processing will be described by using FIGS. 21 and 22. FIGS. 21 and 22 are diagrams for explaining operation sequence classification processing. Then, the analysis unit 12a classifies each divided operation set into classes on the basis of the number of types of operations common to the operation sets. For example, the analysis unit 12a compares the types of operations of an operation set appearing in a classified class with the types of operations of an operation set to be classified, and calculates the number of common operation types. Then, the analysis unit 12a classifies the classification target operation set into a class in which the number of common operation types is equal to or greater than a threshold value and is the largest, and if the number of common operation types is equal to or smaller than the threshold value, the analysis unit 12a classifies the operation set into a new class. As a result, the analysis unit 12a classifies the divided operation sets into classes 1 to 3 as illustrated as an example in FIG. 21, for example.

Furthermore, the analysis unit 12a may classify operation sets in descending order from the largest number of operation types, for example. In this case, the analysis unit 12a obtains the number of operation types for each operation set, starts the classification processing from the operation set “opqrstuvwxyz” having the largest number of operation types, and initially classifies the operation set as “class 1” as illustrated as an example in FIG. 22, for example. Subsequently, the analysis unit 12a compares the operation set “abcdefgabcdefefg” having the next largest number of operation types with “opqrstuvwxyz” classified into class 1 and calculates the number of common operation types (common operation set). Here, since the number of common operation types is “0”, the analysis unit 12a classifies the operation set “abcdefgabcdefefg” into a new class 2.

In this manner, the analysis unit 12a can classify each operation into works by classifying the divided operation sets into classes. As described above, in the operation sequence of FIG. 14, each operation of “abcdefg” is an operation of work 1, each operation of “hijklmn” is an operation of work 2, and each operation of “opqrstuvwxyz” is an operation of work 3. In the example of FIG. 21, the information processing apparatus 10 classifies the operation set “abcdefgabcdefefg” and the operation set “abcdefg” into the class 2 as a group of a series of works in the same work type. Also, the analysis unit 12a classifies the operation set “opqrstuvwxyz” into the class 1 as a group of a series of works in the same work type, for example. Furthermore, the analysis unit 12a classifies the operation set “hijkmklmn” and the operation set “hijklmn” into the class 3 as a group of a series of works in the same work type. In this manner, the analysis unit 12a can extract operation logs as groups of a series of works and classify the groups into work types. The analysis unit 12a classifies the groups into work types and provides a work ID to each group of a series of works.

### [Case ID Specifying Processing]

Next, case ID specifying processing will be described. It is assumed that in the following case ID specifying processing, operation logs 121 are classified for each work ID (label) applied in the aforementioned work ID specifying processing and the case ID specifying processing is performed on each case, for example.

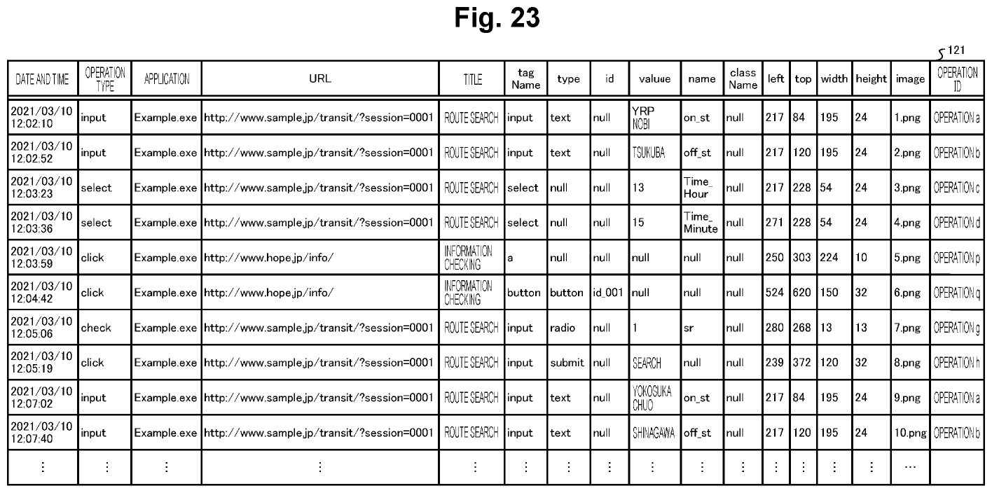

Here, an example of the operation logs 121 used for the description here will be described. FIG. 23 is a diagram illustrating an example of the operation logs 121. As illustrated in FIG. 23, each operation log 121 is a group of records corresponding to each event occurring in response to an operation performed on the terminal device 20. Each column of the operation log 121 in FIG. 23 will be referred to as an attribute. Also, a value of each record (row) of the operation log 121 for each attribute will be referred to as an attribute value.

Additionally, it is assumed that the operation log 121 in FIG. 23 is information regarding an operation performed on a web browser. The attributes of the operation log 121 are not limited to those illustrated in FIG. 23. The attribute of the operation log 121 may include a history of inputs from an input device (such as a keyboard or a mouse) and character sequences of commands input on a character user interface (CUI), for example.

The terminal device 20 executes a web browser, causes a web page to be displayed on a screen, and receives an operation such as an input to a GUI part on the web page. The operation log 121 is information regarding an operation performed on the web page.

The attributes included in the operation log 121 are as follows.
Date and time: time information (including date) when an event has occurred
Operation type: a character sequence indicating an operation type
Application: a character sequence indicating a name of an executed file of an application that is being executed
URL: a character sequence indicating URL of a web page that is being displayed
Title: a character sequence indicating a title of the web page
tagName: a character sequence indicating a tag including a GUI part
type: a character sequence indicating a GUI part type
value: a character sequence indicating a value input to the GUI part
id: a character sequence for identifying the GUI part
name: a character sequence indicating a name of the GUI part
className: a character sequence indicating a name of a GUI part class
left: a numerical value indicating the position of the GUI part
top: a numerical value indicating the position of the GUI part
width: a numerical value indicating the position of the GUI part
height: a numerical value indicating the position of the GUI part
image: data of a captured image of a screen (for example, a character sequence indicating a file path)

Each attribute may correspond to an HTML tag of the same name. Also, a null value is set for an attribute that has not been set or an attribute for which any attribute value has not been able to be acquired, in the operation log 121.

Note that it is not necessary that the attribute value included in the operation log 121 be information itself acquired from the terminal device 20. The attribute value may be obtained by processing the acquired information or may be a combination of a plurality of pieces of information. Also, the plurality of pieces of information to be combined may be information that does not appear in the operation log 121.

Note that the attribute “operation ID” is information for identifying an operation of an event indicated in each record. A method for specifying the operation ID will be described later.

For example, information regarding an event that occurred at “2021 Mar. 10 12:02:10” when an application “Example.exe” displayed a web page with a URL http://www.sample.jp/transit/?session=0001 is indicated in the record of the first row in FIG. 23.

Also, the fact that a value “YRP NOBI” was input to a GUI part with tagName “input”, type “text”, id “null”, and name “on st” in the screen with the title “route search” is indicated in the record of the first row in FIG. 23.

In addition, the fact that the GUI part is at the position indicated by left “217”, top “84”, width “195”, and height “24” is indicated in the record of the first row in FIG. 23. Moreover, the fact that a captured image of the screen at the time of the operation is stored in a file “1.png” is indicated.

Note that the GUI part includes a text box, a button (including one for transmission (submit)), a pull-down, a check box, a radio button, or the like.

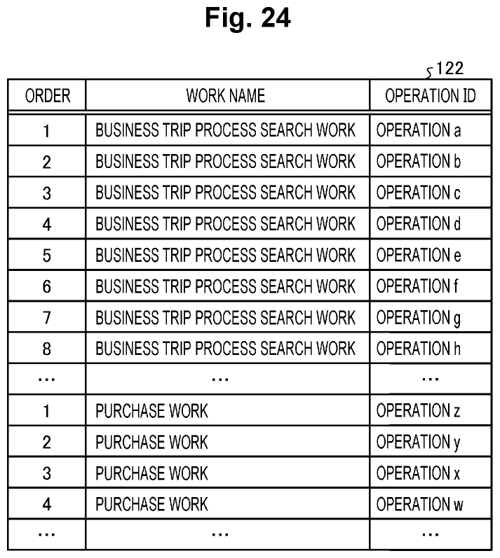

FIG. 24 is a diagram illustrating an example of work model information 122. The work model information 122 stores work models. As illustrated in FIG. 24, the work models are combinations of operations and order patterns. The operations are represented by operation IDs.

FIG. 24 illustrates that a work model with a work name “business trip process search work” has a pattern of a combination of an operation a, an operation b, an operation c, an operation d, an operation e, an operation f, an operation g, and an operation h in this order.

Note that the work models may be identified by work names as in FIG. 24 or may be identified by IDs which are provided for the respective work models.

The analysis unit 12a specifies an operation corresponding to an event indicated in the operation log 121 of a computer.

The analysis unit 12a specifies an operation ID on the basis of each attribute value of the operation log 121. The operation ID is an ID for identifying the event (record) corresponding to the same operation.

In other words, different events may occur even when the same operations are performed on the terminal device 20. On the contrary, different events may be regarded as being caused by the same operation.

For example, both an incident in which a character sequence “abc” is input to a certain text box and an incident in which a character sequence “xyz” is input to the text box are caused by the operation of “inputting a character sequence to the text box”. On the other hand, the input character sequences are different, and the incidents are regarded to be mutually different events.

The analysis unit 12a specifies the event caused by the same operation by applying any of rules of (1) determining a character sequence in a case of complete matching with each attribute of the operation log 121, (2) determining a character sequence in a case of partial matching therewith, (3) making determination within a range of numerical values, and (4) not using them.

The analysis unit 12a applies (1) to the operation type, the application, tagName, type, id, and name from among the attributes of the operation log 121. The analysis unit 12a applies (2) to the URL and the title from among the attributes of the operation log 121. The analysis unit 12a applies (3) to the width and the height from among the attributes of the operation log 121. The analysis unit 12a applies (4) to the date and time, value, className, left, and top from among the attributes of the operation log 121.

For example, the analysis unit 12a sets the operation ID of the records of the first row and the ninth row of the operation log 121 illustrated in FIG. 23 to “operation a”. For example, the operation types and the applications of the records of the first row and the ninth row match, while the dates and times and values do not match.

The analysis unit 12a creates a work model which is information in which a combination of specified operations and an order pattern are associated with works in the business operation. The work model is a model representing a series of operations performed to complete the works in the business operation.

The analysis unit 12a may create the work model according to user's designation received through a work model creation screen. For example, the analysis unit 12a creates the work model on the basis of an operation associated with a captured image selected by the user in a captured image of a computer screen from among operations.

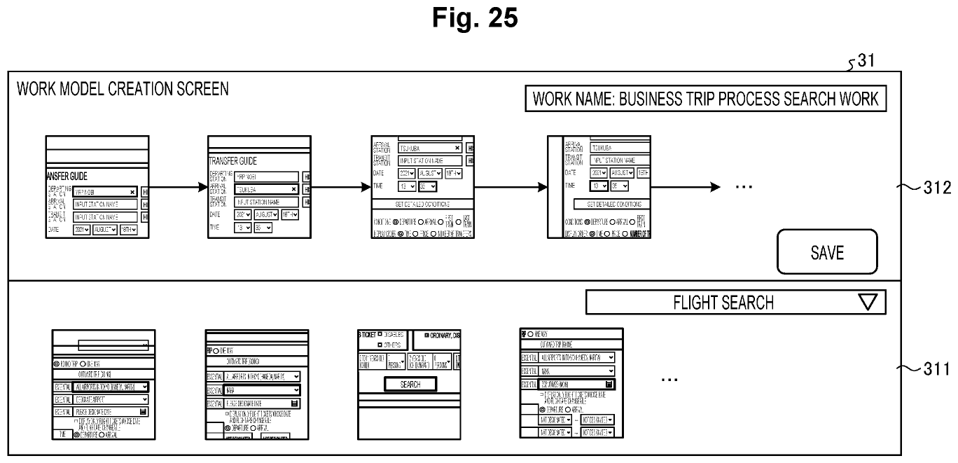

FIG. 25 is a diagram illustrating an example of the work model creation screen. For example, a work model creation screen 31 is created by the analysis unit 12a and is displayed by the terminal device 20. Also, the work model creation screen 31 may be displayed by a device that is different from the terminal device 20.

The analysis unit 12a extracts the operation ID of the operation log 121 and the captured image associated with the operation ID and displays the captured image for each operation ID in a region 311. Note that the analysis unit 12a extracts the captured image with reference to “image” of the operation log 121.

Also, auxiliary information regarding the captured image is displayed in the region 311. For example, the fact that the captured image is an image of a flight search screen is indicated in the region 311 of FIG. 25.

The analysis unit 12a may display the captured image in the region 311 for each piece of information regarding the screen (the title, the URL) to facilitate user's selection.

Also, the analysis unit 12a may cut only the surroundings of the operation location in the captured image for easy view of the display of the operation location or may display the part corresponding to the operation location on the captured image in an emphasized manner by using information (top, left, width, height) of the operation location (the thick frame part in the captured image in the region 311).

The user selects the captured image illustrated in the region 311 and designates an order. For example, the user moves the captured image selected in the region 311 to a region 312.

In the region 312, the selected captured image is arranged and displayed at a position corresponding to the designated order. Also, a text box for inputting a work name is provided in the region 312. In the example of FIG. 25, “business trip process search work” is input as a work name.

The analysis unit 12a associates and stores in the work model information 122, the operation ID of the operation corresponding to the captured image arranged in the region 312, the order based on the arrangement position, and the input work name at a timing at which a save button is pressed, for example.

The analysis unit 12a applies first information (work information) which is information indicating the corresponding work to each event indicated in the operation log 121 by using the work model.

For example, the analysis unit 12a applies information indicating the work included in the work model as work information to continuous events in a series, in which the events indicated in the operation log 121 are arranged in accordance with the dates and times of occurrence, which meet a condition regarding a degree of matching with the pattern included in the work model.

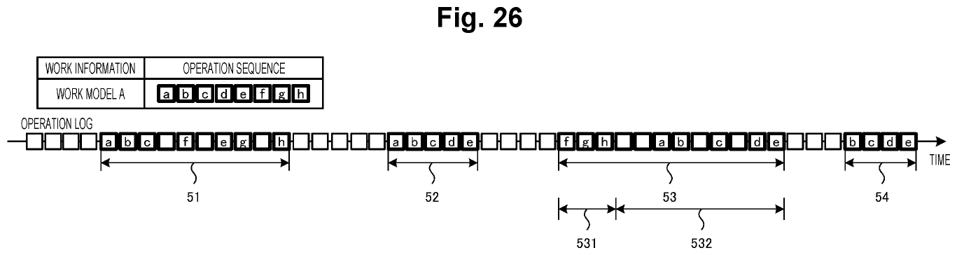

FIG. 26 is a diagram for explaining an information providing procedure. In the series of FIG. 26, the events of the operation log 121 are aligned in the order of dates and times of occurrence. The rectangular figure corresponds to each event, and alphabets represent operation IDs. For example, the operation ID “operation a” is abbreviated as “a” in FIG. 26.

Also, the blank figures with no operation IDs described therein correspond to events for which the operation IDs have not been specified or events which have operation IDs with no relationship with the target work model.

The analysis unit 12a views the events in the series in order and specifies a range with a likelihood of matching with the work model. For example, the analysis unit 12a specifies continuous events with operation IDs whose arrangement is the same as that of a series of operation IDs of the work model (operation sequence).

For example, the analysis unit 12a detects an event with an operation ID “a” as a start point from the sequence. “a” is an operation ID of the first order in the work model A.

Then, the analysis unit 12a determines whether or not the operation ID of the event following the specified start point is included in the work model.

Also, the analysis unit 12a may determine that an event whose operation ID is not included in the work model but has a title of a URL that coincides with that of an event determined to be included in the work model is also included in the work model.

Then, the analysis unit 12a defines an event immediately before the event which is determined not to be included in the work model as an end point.

Then, the analysis unit 12a specifies the range from the start point to the end point. In the example of FIG. 26, the analysis unit 12a specifies a range 51, a range 52, a range 53, and a range 54 as ranges that can match the work model A.

Next, the analysis unit 12a determines whether or not to provide work information corresponding to the work model to the specified ranges. The analysis unit 12a makes the determination on the basis of at least any of the degree of matching of elements and the length of the sequence.

The analysis unit 12a views each event in the specified ranges, and adds 1 to the degree of matching in a case where the operation ID of the event coincides with the operation ID in the work model, or adds 0.5 to the degree of matching in a case where the operation ID of the event does not coincide with the operation ID in the work model (corresponding to the blank figure).

The analysis unit 12a calculates the number of matchings between the operation IDs of the events within the specified ranges and the operation IDs of the work model as the length of the sequence.

For example, the analysis unit 12a calculates the degree of matching as 9.0 for the range 51 and calculates the length of the sequence as 7.

The analysis unit 12a provides work information to each event within a range in which at least one of or both the degree of matching and the length of the sequence exceed threshold values. For example, the threshold value of the length of the sequence may be a value such as 50% of the number of operation IDs of the work model.

For example, it is assumed that the degree of matching within the range 51 and the length of the sequence exceed the threshold values and the work name of the work model A is “business trip process search work”. In this case, the analysis unit 12a applies “business trip process search work” to the attribute “work name”, which has been added to the operation log 121, of the event included in the range 51.

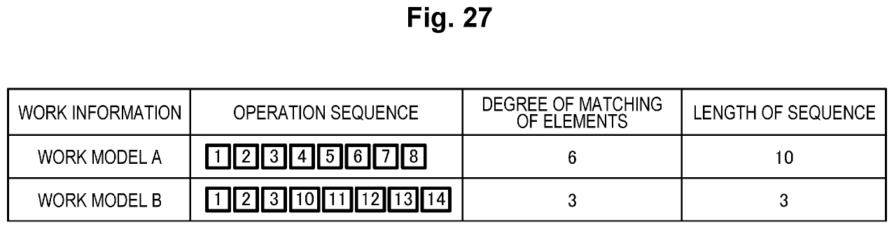

Also, the range specified by the analysis unit 12a can correspond to a plurality of work models. As illustrated in FIG. 27, for example, a case where the range 51 can correspond to both the work model A and the work model B will be considered. FIG. 27 is a diagram for explaining an information providing procedure.

In this case, the analysis unit 12a determines which of the work models the specified range is closer to depending on the degree of matching and the length of the sequence.

In the example in FIG. 27, both the degree of matching and the length of the sequence are higher in the work model A, and the analysis unit 12a thus determines that the work model A corresponds to the range 51.

Also, the analysis unit 12a may determine the work model with a larger weighted sum of the degree of matching and the length of the sequence as shown below as the work model corresponding to the specified range.

Weighted sum=degree of matching×1+length of sequence×2

The analysis unit 12a provides second information (case information) which is information indicating a corresponding case to each event with the work information provided thereto from among the events indicated in the operation log 121 on the basis of the captured image of the computer screen.

Events within the range with the work information provided thereto by the analysis unit 12a can have occurred by repeated operations regarding one or more cases. Therefore, the analysis unit 12a further provides case information to the events within the range with the work information provided thereto.

The exemplary case in which the analysis unit 12a further provides case information to the range with the work information corresponding to the work model A provided thereto will be described.

The analysis unit 12a provides case information to two events on the basis of a result of determining whether or not the two events correspond to the same case by comparing information regarding a computer screen corresponding to each of the two continuous events in a sequence in which the events with the work information provided thereto are arranged in accordance with the dates and times of occurrence from among the events indicated in the operation log 121.

First, the analysis unit 12a defines an event with an operation ID that coincides with the operation ID of the first order in the work model as a start point of the case. For example, the operation ID of the first order in the work model A is “a”.

The analysis unit 12a determines whether or not to provide the same case information as that for the first event to the second event out of the two continuous events after the start point.

Here, it is assumed that work information has been provided to the range 51, the range 52, the range 53, and the range 54. Also, the analysis unit 12a focuses only on the events with the work information provided thereto. In other words, an event that continues the event at the right end of the range 51 is regarded as an event at the left end of the range 52.

First, the analysis unit 12a provides the same case information to the two continuous events in a case where the screen of the two continuous events is the same and all the following conditions C1 to C4 are satisfied.

Also, the analysis unit 12a provides the same case information to the two continuous events in a case where the screens of the two continuous events are not the same and the conditions except for the condition C3 from among the following conditions C1 to C4 are satisfied.

Note that whether or not the screens are the same is determined on the basis of whether or not the titles of the operation logs 121 are the same. Also, in a case where the same case information is not provided through the above procedure, a case information providing unit 134 provides case information which is different from that for the first event to the second event.

### (Condition C1)

The operation ID of the second event is not the operation ID of the first order in the work model.

### (Condition C2)

Window handles of the screens of the two events are identical.

### (Condition C3)

A template matching score for determining whether or not a captured image of an operation location of the first event is included in a captured image of a screen of the second event is equal to or greater than a threshold value. However, the operation location is acquired from the captured image of the screen and left, top, width, and height of the operation log 121.

### (Condition C4)

A difference between the dates and times of occurrence of the first event and the second event is equal to or less than a threshold value.

Also, the analysis unit 12a defines an event with an operation ID that coincides with the operation ID of the last order in the work model as an end point of the case regardless of the above conditions. For example, the operation ID of the last order in the work model A is “h”.

In the example of FIG. 26, the analysis unit 12a provides the same case information (information indicating the case α) to the range 51, the range 52, and the range 531. On the other hand, the analysis unit 12a provides the same case information (information indicating the case β) to the range 532 and the range 54. Even the ranges which are continuous and have the same work information provided thereto, like the range 531 and the range 532, may have mutually different case information.

Returning to explanation of FIG. 1, the visualization unit 12b visualizes the image including an object on the basis of the attribute information specified by the analysis unit 12a, where the object is an object of operation logs in predetermined units and is selectable by an operation of the user. For example, the visualization unit 12b visualizes an image including the object on the basis of the work ID, the business operation ID, and the case ID specified by the analysis unit 12a, where the object is an object of operation logs in predetermined units and is selectable by an operation of the user.

As display modes, the visualization unit 12b visualizes the image in three modes, namely “time line”, “process visualization”, and “operation column visualization”, for example. The visualization unit 12b displays a list of used applications, windows, files, and the like along a time axis for each date and time, work, business operation, or the like as a time line. For example, the visualization unit 12b visualizes a time line as an object in a plurality of hierarchies on the basis of one or more attributes from among the user who has performed the operation, the terminal with which the operation has been performed, the date and time when the operation has been performed, the name of the application as the operation target, the window title of the operation target, and the file name of the operation target, as the image including the object.

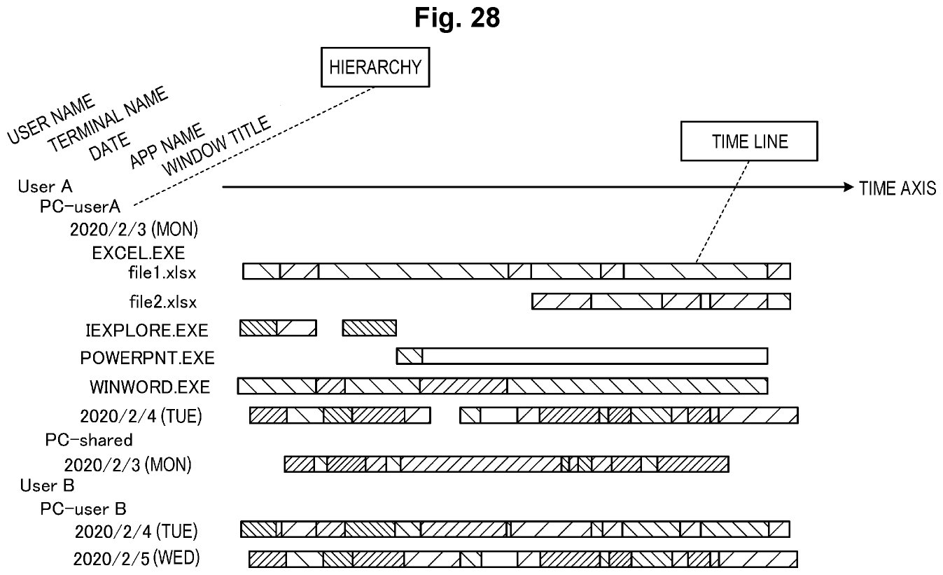

Here, an example of a screen visualized in which the operation logs are visualized in a time line format will be described by using the example of FIG. 28. FIG. 28 is a diagram illustrating an example of a screen in which the operation logs are visualized in the time line format. It is assumed that any one or more pieces of attribute information from among the business operation ID, the work ID, the case ID, and the operation type ID of the display target have been designated for the visualization unit 12b. As illustrated as an example in FIG. 28, the visualization unit 12b displays, as a list, the time in the horizontal axis direction and objects included the focused attribute types (hierarches) in the vertical axis direction in the time line format on the basis of the operation logs with the designated attribute information. In the time line of FIG. 28, the location of the time periods of utilization are displayed with colors, and “active” or “non-active” is further displayed with color darkness. Also, the visualization unit 12b displays, in a hierarchical manner, attributes associated with the operation log, such as a user name, a terminal name, a date, an App name, a window title, a file name, and the like. Additionally, the hierarchies can be exchanged, developed, or convoluted by an operation of the user.

The visualization unit 12b can designate an object to be passed to the RPA cooperation unit 12c by the following method for a characteristic work region and further has a function of transmitting it to the RPA cooperation unit 12c, which will be described later, by a simple operation such as dragging and dropping. It is assumed that the user can select a displayed object. As a method for designating an object, a rectangle, a row, selection, or operation may be selected, or a range is selected by drawing a rectangle, for example. Also, ranges to be selected may differ depending on the operation positions. For example, a plurality of rows are selected in a case where an operation is performed on a row label, and a time period is selected in a case where an operation is performed on the time axis.

In addition, the visualization unit 12b may visualize the image including nodes indicating operation content and edges indicating operation orders on the basis of the attribute information, as the image including the object, for example. For example, the visualization unit 12b receives designation of any one or more pieces of attribute information from among the business operation ID, the work ID, the case ID, and the operation type ID of the display target and acquires a captured screen of the operation screen for the operation log with the designated attribute information provided thereto from the operation log storage unit 13a. Note that the attribute information is not limited to the business operation ID, the work ID, the case ID, and the operation type ID, and a user or date and time designation may be received. Then, the visualization unit 12b creates and displays a screen obtained by connecting the nodes with the edges by using the captured screens of the acquired operation screen as the nodes.

For example, the visualization unit 12b may display, in the flow format connected with arrows, the nodes for which the operations of the same type are superimposed for each case in order to recognize the flow of the operation for each business operation/work as process visualization.

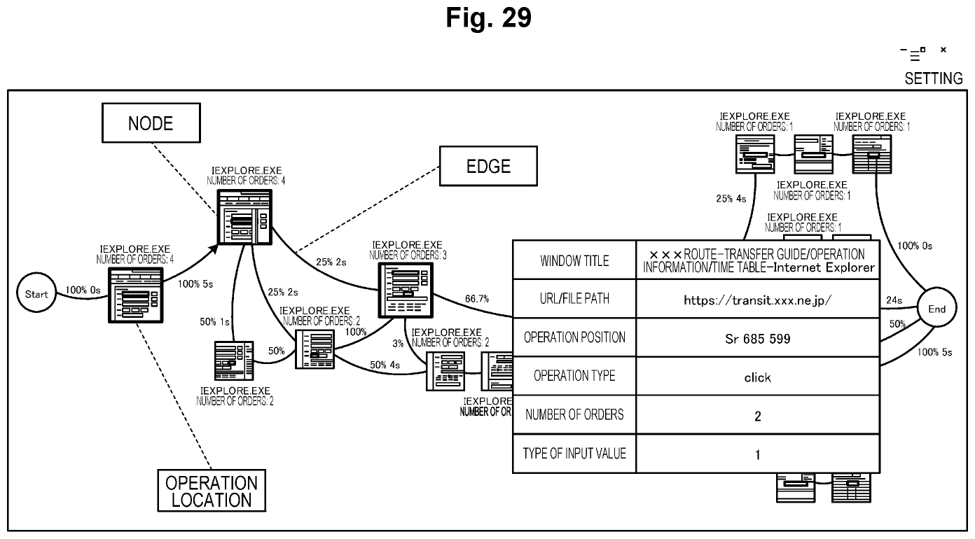

Here, a screen in which an operation process is visualized will be described by using the example of FIG. 29. FIG. 29 is a diagram illustrating an example of the screen in which the operation process is visualized. It is assumed that any one or more pieces of attribute information from among the business operation ID, the work ID, the case ID, and the operation type ID of the display target have been designated for the visualization unit 12b. As illustrated as an example in FIG. 29, the visualization unit 12b visualizes the operation process with nodes (boxes) and edges (arrows) on the basis of the attribute information (the business operation ID, the work ID, the case ID, and the operation type ID) provided by the analysis unit 12a. The visualization unit 12b superimposes and displays the same operation type ID as one node for each business operation ID or each work ID. An object to be passed to the RPA cooperation unit 12c can be designated by selecting an object or selecting a range by drawing a rectangle for a characteristic work region, and can further be transmitted to the RPA cooperation function by a simple operation such as dragging and dropping.

In the example of FIG. 29, the visualization unit 12b represents actions (an application, a window, an operation) in the process as nodes, and displays operations performed at the same operation location or operations with the same sequence index as one node. Note that the thick frame in each node indicates the operation location. In addition, the visualization unit 12b displays edges indicating the operation orders by the directions of the arrows.

In addition, the visualization unit 12b may visualize the captured screens of the operation screen in the chronological order on the basis of the attribute information, as the image including the object. For example, the visualization unit 12b receives designation of any one or more pieces of attribute information from among the business operation ID, the work ID, the case ID, and the operation type ID of the display target and acquires captured screens of the operation screen for the operation logs with the designated attribute information provided thereto from the operation log storage unit 13a. Note that the attribute information is not limited to the business operation ID, the work ID, the case ID, and the operation type ID, and a user or date and time designation may be received. Then, the visualization unit 12b creates and displays a screen obtained by arranging the acquired captured screens of the operation screen in the chronological order. In this manner, the visualization unit 12b displays the operations for each date, business operation, or work in the chronological order in order to recognize the flow of the operations as the operation column visualization, for example.

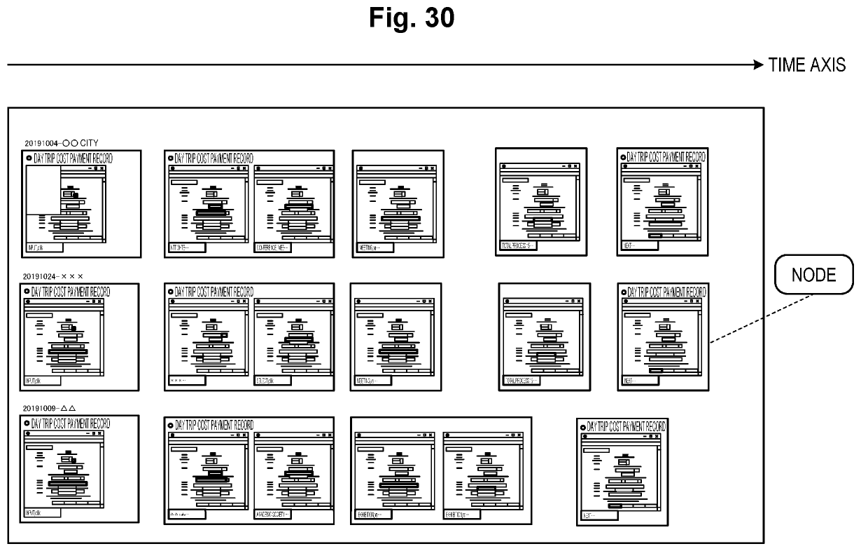

Here, a screen in which operations are visualized in predetermined units will be described by using the example of FIG. 30. FIG. 30 is a diagram illustrating an example of a screen in which operations are visualized in predetermined units. The visualization unit 12b acquires operation logs in units of business operations, works, cases, logs, and users & dates on the basis of attribute information (the business operation ID, the work ID, the case ID, and the operation type ID) provided by the analysis unit 12a, and visualizes an operation column using the operation logs. The visualization unit 12b displays, as each node, the captured image of the operation screen centered on the operation location in the order of operations, and an analyst can thus utilize the captured image to specify the operation location and the content.

The visualization unit 12b receives designation of an object to be passed to the RPA cooperation unit 12c through selection of an object or selection of a range in display units, and further transmits the object to the RPA cooperation unit 12c, which will be described later, by a simple operation such as dragging and dropping.

Next, in a case where the object included in the image visualized by the visualization unit 12b has been selected by an operation of the user, the RPA cooperation unit 12c generates a feasible automatic operation program on the basis of the selected object. The RPA cooperation unit 12c has a function capable of creating the automatic operation flow on the basis of an object selected by the user.

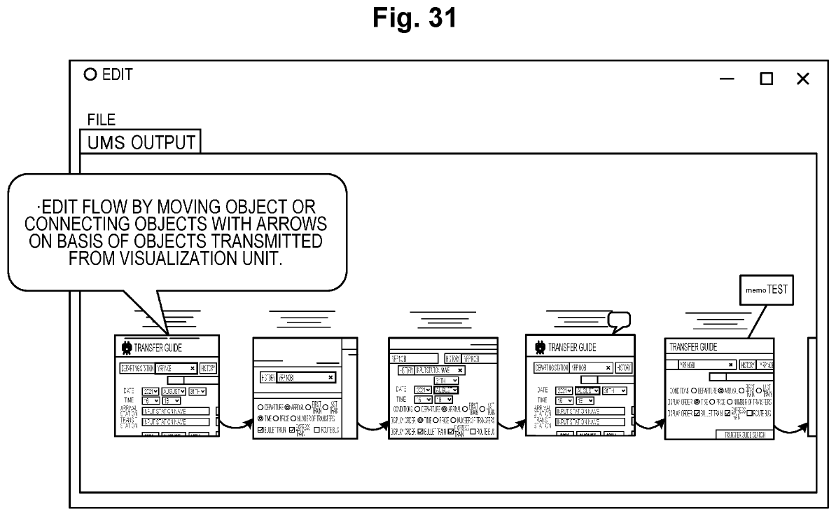

Here, the exemplary screen on which the user creates a desired automatic operation flow will be described by using FIG. 31. FIG. 31 is a diagram illustrating an exemplary screen on which the user creates a desired automatic operation flow. As illustrated in FIG. 31, the RPA cooperation unit 12c has a function capable of displaying the operation nodes transmitted from the visualization unit 12b and connecting the nodes by the operation of the user in order for the user to create the desired automatic operation flow. The RPA cooperation unit 12c displays the nodes visualized by the visualization unit 12b and connects the nodes to each other on the basis of a user operation. For example, as illustrated as an example in FIG. 31, the RPA cooperation unit 12c can edit the automatic operation flow by moving objects and connecting objects by arrows on the basis of the objects transmitted from the visualization unit 12b.

The RPA cooperation unit 12c outputs the flow created by the user as the automatic operation program. In other words, the RPA cooperation unit 12c outputs the generated automatic operation flow as an automatic operation program executable by various RPA tools. For example, the RPA cooperation unit 12c reads the operation flow in order and generates the automatic operation program by matching the application, the window title, the operation location, and the captured image associated the object with the format of the RPA tool.

In this manner, since the information processing apparatus 10 allows the user to understand analysis results, discovers points to be improved in the business operations, and assists examination of measures for improvement, it is possible to observe the analysis results from various aspects, to deeply consider the specific regions, and in a case where an object as a target of an automatic operation is specified, it is possible to generate the automatic operation flow on the basis of the object.

### [Processing Procedure of Information Processing Apparatus]

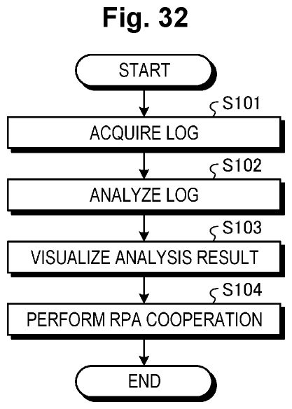

Next, a processing procedure of the classification processing performed by the information processing apparatus 10 will be described by using FIG. 32. FIG. 32 is a flowchart illustrating an example of a processing procedure of operation log acquisition processing according to the embodiment.

As illustrated in FIG. 32, the analysis unit 12a of the information processing apparatus 10 acquires an operation log related to operation information (Step S101) and analyzes the operation log (Step S102). Then, the attribute information of the operation log of the analysis unit 12a is specified.

Next, the visualization unit 12b visualizes an image including an object on the basis of the attribute information specified by the analysis unit 12a, where the object is an object of operation logs in predetermined units and is selectable by an operation of the user (Step S103). First, the visualization unit 12b visualizes the image including the object on the basis of the work information, the business operation information, and the case information specified by the analysis unit 12a, where the object is an object of operation logs in predetermined units and is selectable by an operation of the user.

Thereafter, in a case where the object included in the image visualized by the visualization unit 12b is selected by the operation of the user, the RPA cooperation unit 12c performs RPA cooperation processing of generating an automatic operation flow on the basis of the selected object (Step S104).

### [Effects of Embodiment]

As described above, the information processing apparatus 10 according to the embodiment acquires an operation log regarding operation information, analyzes the operation log, and specifies attribute information of the operation log. Then, the information processing apparatus visualizes an image including an object on the basis of the specified attribute information, where the object is an object of operation logs in predetermined units and is selectable by an operation of a user. Next, the information processing apparatus generates a feasible automatic operation program on the basis of the selected object in a case where the object included in the visualized image is selected by the operation of the user. Therefore, the information processing apparatus 10 can visualize the operation process and easily create the automatic operation program.

In other words, although a mechanism for finding a repeated work through statistical analysis on the basis of operation logs in order to assist introduction of RPA is conventionally known, there has been no mechanism using the results as inputs to an RPA tool. Therefore, there has been a problem that it is necessary to manually create an automatic operation program with the RPA tool while viewing analysis results with the RPA tool separately activated and it takes time and effort.

On the other hand, the information processing apparatus 10 according to the embodiment can reduce time and efforts to create the automatic operation program by a mechanism of coupling the analysis function to an editing function such that the analysis results can be directly used as inputs to the automatic operation program and further outputting an edited scenario to a feasible automatic operation program file. As a result, it is possible to greatly reduce time and effort for introducing the RPA and thereby to quickly realize an improvement for more effective business operations.

### [Regarding System Configuration of the Embodiment]

Each component of the information processing apparatus 10 illustrated in FIG. 1 is functionally conceptual, and does not necessarily need to be physically configured as illustrated. In other words, specific forms of distribution and integration of the functions of the information processing apparatus 10 are not limited to the illustrated forms, and all or some thereof can be functionally or physically distributed or integrated in arbitrary units according to various loads, usage conditions, and the like.

In addition, all or an arbitrary part of the processing performed in the information processing apparatus 10 may be implemented by a CPU and a program analyzed and executed by the CPU. Moreover, processing performed in the information processing apparatus 10 may be implemented as hardware based on a wired logic.

In addition, among the pieces of the processing described in the embodiment, all or a part of the processing described as being automatically performed can be performed manually. Alternatively, all or a part of the processing described as being manually performed can be automatically performed by a known method. In addition, the above-described and illustrated processing procedures, control procedures, specific names, and information including various kinds of data and parameters can be appropriately changed unless otherwise specified.

### [Program]

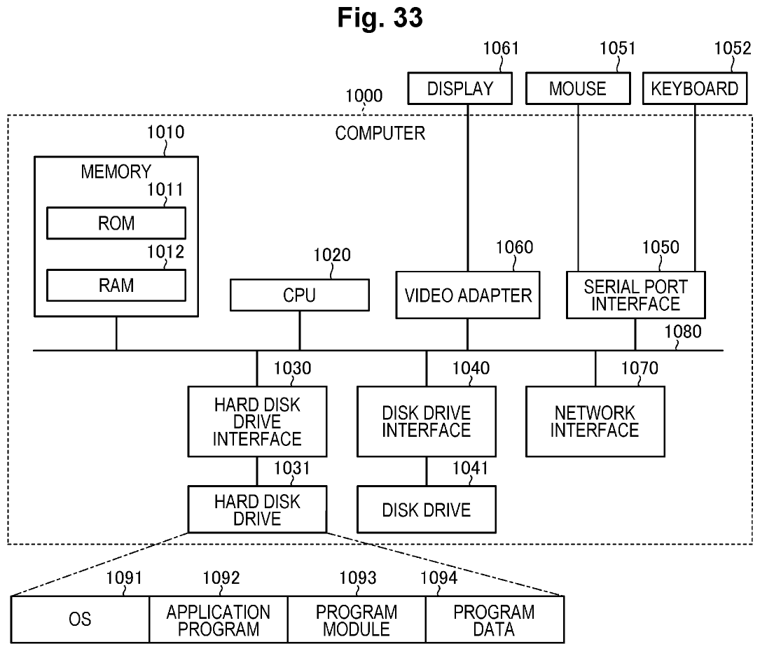

FIG. 33 is a diagram illustrating an example of a computer which realizes the information processing apparatus 10 by executing a program. A computer 1000 includes a memory 1010 and a CPU 1020, for example. In addition, the computer 1000 includes a hard disk drive interface 1030, a disk drive interface 1040, a serial port interface 1050, a video adapter 1060, and a network interface 1070. These units are connected to each other via a bus 1080.

The memory 1010 includes a ROM 1011 and a RAM 1012. The ROM 1011 stores a boot program such as a basic input output system (BIOS), for example. The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to a mouse 1051 and a keyboard 1052, for example. The video adapter 1060 is connected to a display 1061, for example.

The hard disk drive 1031 stores an operating system (OS) 1091, an application program 1092, a program module 1093, and program data 1094, for example. In other words, a program that defines each processing of the information processing apparatus 10 is implemented as the program module 1093 in which a code that is executable by the computer 1000 is described. The program module 1093 is stored in the hard disk drive 1031, for example. For example, the program module 1093 for executing processing similar to the functional configuration in the information processing apparatus 10 is stored in the hard disk drive 1031. Note that the hard disk drive 1031 may be replaced with a solid state drive (SSD).

Also, the setting data that is used in the processing according to the above embodiments is stored as the program data 1094 in the memory 1010 or the hard disk drive 1031, for example. The CPU 1020 then reads the program module 1093 and the program data 1094 stored in the memory 1010 or the hard disk drive 1031 into the RAM 1012 as necessary and executes them.

Note that the program module 1093 and the program data 1094 are not necessarily stored in the hard disk drive 1031, but may be stored in a removable storage medium and be read by the CPU 1020 via the disk drive 1041 or the like, for example. Alternatively, the program module 1093 and the program data 1094 may be stored in another computer connected via a network (a local area network (LAN), a wide area network (WAN), or the like). The program module 1093 and the program data 1094 may then be read from another computer by the CPU 1020 via the network interface 1070.

While the embodiment to which the invention made by the present inventors is applied has been described above, the present invention is not limited by the description and the drawings constituting part of the disclosure of the above embodiment according to the present invention. In other words, other embodiments, examples, operation techniques, and the like made by those skilled in the art and the like on the basis of the above embodiment are all included in the scope of the present invention.

### REFERENCE SIGNS LIST

10 Information processing apparatus
11 Communication unit
12 Control unit
12a Analysis unit
12b Visualization unit
12c RPA cooperation unit
13 Storage unit
13a Operation log storage unit
20 Terminal device
21 Operation log acquisition unit

1. An information processing apparatus comprising:
an analysis unit, comprising one or more processors, configured to acquire an operation log regarding operation information, analyze an operation log, and specify attribute information of the operation log;
a visualization unit, comprising one or more processors, configured to visualize an image including an object on the basis of the attribute information specified by the analysis unit, the object being an object of operation logs in predetermined units and being selectable by an operation of a user; and
a cooperation unit, comprising one or more processors, configured to generate a feasible automatic operation program on the basis of a selected object in a case where the object included in the image visualized by the visualization unit is selected by the operation of the user.

2. The information processing apparatus according to claim 1,
wherein the analysis unit is configured to specify business operation information indicating content of a business operation of the operation log, specify work information indicating content of work of the operation log included in each piece of the specified business operation information, and specify case information of the operation log included in each piece of the specified content of work, and
the visualization unit is configured to visualize an image that includes objects of operation logs in predetermined units, which are selectable by the operation of the user, on the basis of the work information, the business operation information, and the case information specified by the analysis unit.

3. The information processing apparatus according to claim 1, wherein the visualization unit is configured to visualize a time line as the object in a plurality of hierarchies on the basis of any one or more of attributes from among the user who has performed the operation, a terminal with which the operation has been performed, a date on which the operation has been performed, a name of an application as an operation target, a window title of the operation target, and a file name of the operation target, as the image including the object.

4. The information processing apparatus according to claim 1, wherein the visualization unit is configured to visualize an image including nodes indicating operation content and edges indicating operation orders on the basis of the attribute information, as the image including the object.

5. The information processing apparatus according to claim 1, wherein the visualization unit is configured to visualize captured screens of an operation screen in a chronological order on the basis of the attribute information, as the image including the object.

6. The information processing apparatus according to claim 4, wherein the cooperation unit is configured to display the nodes visualized by the visualization unit and connect the nodes on the basis of an operation of the user.

7. An information processing method that is executed by an information processing apparatus, the method comprising:
acquiring an operation log regarding operation information, analyzing the operation log, and specifying attribute information of the operation log;
visualizing an image including an object on the basis of the attribute information, the object being an object of operation logs in predetermined units and being selectable by an operation of a user; and
generating a feasible automatic operation program on the basis of a selected object in a case where the object included in the image is selected by the operation of the user.

8. A non-transitory computer readable medium storing a program, wherein execution of the program causes a computer to perform operations comprising:
acquiring an operation log regarding operation information, analyzing an operation log, and specifying attribute information of the operation log;
visualizing an image including an object on the basis of the attribute information, the object being an object of operation logs in predetermined units and being selectable by an operation of a user; and
generating a feasible automatic operation program on the basis of a selected object in a case where the object included in the image is selected by the operation of the user.
